(19) United States
(12) Patent Application Publication
(10) Pub. No.: US 2005/0267246 A1
(43) Pub. Date: Dec. 1, 2005

(54) Abrasion resistant fluoropolymer compositions containing zeolite

(76) Inventor: Laurence Waino McKeen, Sewell, NJ (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/138,249

(22) Filed: May 26, 2005

Related U.S. Application Data
(60) Provisional application No. 60/575,321, filed on May 28, 2004.

(51) Int. Cl. C08K 3/34

(52) U.S. Cl. 524/450

(57) ABSTRACT

The present invention provides an abrasion resistant overcoat composition comprising fluoropolymer and an effective amount of zeolite to increase the abrasion resistance of a film formed from the composition by at least 25% as compared to film formed from the fluoropolymer by itself. The invention also provides for a process for increasing the abrasion resistance of a fluoropolymer film coating on a fuser roll, by forming a film of fluoropolymer with an effective amount of zeolite sufficient to increase the film's abrasion resistance.

### FIELD OF THE INVENTION

This invention relates to fluoropolymer compositions containing additives that increase the abrasion resistance of films formed from the compositions.

### BACKGROUND OF THE INVENTION

Fluoropolymers resins have exceptional stability to light, heat, solvents, chemical attack and electrical stresses, conferring desirable properties to articles made from these polymers or substrates coated with films of the polymers. Such resins, especially perfluoropolymer resins, are known for their low surface energy and release/non-stick characteristics. Mechanical properties such as abrasion resistance can be improved by incorporating additives into these resins and thereby extending their service life, but such addition results in diminishing the release properties of the polymers.

One important application for fluoropolymers is in electrostatographic reproduction wherein electrostatically charged toner is fused to a receiver (e.g., paper or film) making visible a latent electrostatic image. The use of fluoropolymer resin film coatings on heated metal fuser rolls provides a heat resistant polymer film having a release surface that prevents the sticking of toner to the fuser roll and allows more toner to affix to the receiver for production of high quality printed images. The heated fuser roll is heated to a high temperature, usually at about 200° C., to melt the toner particles electrostatically deposited on a receiver and then releases the resultant molten image as it adheres to the receiver. If molten toner particles stay adhered to the fuser roll, they can deposit on a later supplied receiver to provide an undesired image. Thus, the fuser roll coating application of fluoropolymer resin embodies a critical requirement for faithfully releasing molten toner, which by its molten nature and need to stick to the receiver is a sticky material. While fluoropolymer resin coating has been successfully used in this application, the coating suffers from the shortcoming of being abraded away both by the receivers sequentially contacting the fuser roll and even more severely by the picker fingers that rub against the fuser roll surface to remove a receiver from the fuser roll. The problem is how to increase the abrasion resistance of the coating without adversely affecting its release property.

The incorporation of zeolite as an additive is disclosed in U.S. Pat. No. 4,425,448 to Concannon et al. Zeolites are reversibly hydrated aluminum silicates generally containing alkali or alkaline earth metal oxides which sometimes can be ion exchanges for other metal or for hydrogen. Concannon et al. incorporate small amounts (less than 2.6 wt % based on dry film weight) of zeolite, particularly ultramarine blue, into a polytetrafluoroethylene (PTFE) coating composition in order to retard the oxidative degradation of the PTFE resin. Further it is known to incorporate zeolites, such as ultramarine blue, into fluoropolymer primer compositions used in cookware to achieve pigmentation for hiding substrate defects when such thin primer layers are applied and then overcoated with a clear topcoat composition.

However, the references that disclose the advantages of incorporating zeolite additives in fluoropolymers do not address the problem of increasing abrasion resistance in fluoropolymer resins while maintaining the release properties of the polymer, nor do they disclose any application to fuser roll covers. There remains a need for a composition that has the combined attributes of abrasion resistance and release, especially in the area of electrostatographic reproduction.

### BRIEF SUMMARY OF THE INVENTION

The present invention satisfies the need for forming a fluoropolymer film coating composition on a fuser roll such that a film formed from the composition exhibits improved abrasion resistance while maintaining excellent release properties. The process for increasing the abrasion resistance of a fluoropolymer film coating on a fuser roll, comprises incorporating into the fluoropolymer prior to forming the film coating therefrom an effective amount of zeolite sufficient to increase the abrasion resistance of film formed from the composition by at least 25% as compared to film formed from the fluoropolymer by itself.

The invention further relates to an overcoat composition comprising fluoropolymer and an effective amount of zeolite to increase the abrasion resistance of film formed from the composition by at least 25% compared to film formed from said fluoropolymer by itself. Preferably the zeolite is alkali metal aluminum silicate, more preferably ultramarine blue pigment.

The invention also relates to an electrically conductive overcoat composition comprising fluoropolymer, an effective amount of electrically conductive particulate material and an effective amount of zeolite to increase the abrasion resistance of film formed from said composition by at least 25% compared to film formed from said fluoropolymer by itself.

In the fuser roll coating application, the composition will usually contain a small amount electrically conductive particulate material in an effective amount to prevent build up of electrical charge on the fuser roll that could attract toner particles from the receiver prior to contact with and fusing by the fuser roll. This additive has a negligible effect on abrasion resistance of the fluoropolymer resin coating and therefore can be included in the fluoropolymer in the abrasion testing for determining the abrasion resistance of the fluoropolymer by itself.

### DETAILED DESCRIPTION OF THE INVENTION

The improved process and composition of this invention which results in providing both good abrasion resistance and good release is best illustrated by use of this composition as a film coating for fuser rolls in copy machines and laser printers. For example, in electrostatographic reproduction in a copy machine, a uniformly charged imaging roll is exposed to a laser to create a series of electrostatic images. Toner is subsequently applied to each of the images on the imaging roll to create a series of toner images corresponding to the electrostatic images. The toner images are transferred to a receiver such as paper or film. The receiver bearing the toner images is separated from the imaging roll and fed to a fusing apparatus. The fusing apparatus is commonly composed of two rolls which form a nip through which the receiver passes. The top roll is generally a fluoropolymer coated metal roll, hereinafter designated as the “fuser roll”. The second roll, herein after designated as the “support roll”, cooperates with the fuser roll to form the nip and is commonly made of a compliant elastomeric material, such as silicone rubber. The fuser roll is heated, often by an internal heat source disposed in the core of the fuser roll.

The use of fluoropolymer resin film coatings on the heated metal fuser roll provides a heat resistant polymer film having a release surface that prevents the sticking of toner to the fuser roll and allows more toner to affix to the receiver for production of high quality printed images. However, the high volume of paper that passes through a copier and the pressure of the picker fingers on the fuser roll surface have a wearing effect on prior art fluoropolymer coatings causing the coating to wear away, thereby losing its effectiveness as a release surface. As will be shown in the Examples, the fluoropolymer resin composition of the present invention containing an effective amount of zeolite surprisingly improves the abrasion resistance of a film formed from the composition by at least 25%, preferably at least 50%, as compared to film formed from the fluoropolymer by itself. This invention has unexpectedly found that by adding an effective amount of zeolite to fluoropolymer resins there is as much as a 200% improvement in abrasion resistance of a film formed from the composition as compared to film formed from fluoropolymer itself. Further, despite the increased incorporation of the zeolite additive, the release properties of the fluoropolymer film coating are retained.

Fluoropolymers

The fluoropolymer in the composition of the film of this invention is independently selected from the group of polymers and copolymers of trifluoroethylene, hexafluoropropylene, monochlorotrifluoroethylene, dichlorodifluoroethylene, tetrafluoroethylene, perfluorobutyl ethylene, perfluoro(alkyl vinyl ether), vinylidene fluoride, and vinyl fluoride and blends thereof and blends of said polymers with a nonfluoropolymer.

The fluoropolymers used in this invention are preferably melt-processible. By melt-processible it is meant that the polymer can be processed in the molten state (i.e., fabricated from the melt into shaped articles such as films, fibers, and tubes etc. that exhibit sufficient strength and toughness to be useful their intended purpose). Examples of such melt-processible fluoropolymers include copolymers of tetrafluoroethylene (TFE) and at least one fluorinated copolymerizable monomer (comonomer) present in the polymer in sufficient amount to reduce the melting point of the copolymer substantially below that of TFE homopolymer, polytetrafluoroethylene (PTFE), e.g., to a melting temperature no greater than 315° C. Such fluoropolymers include polychlorotrifluoroethylene, copolymers of tetrafluoroethylene (TFE) or chlorotrifluoroethylene (CTFE). Preferred comonomers with of TFE are perfluoroolefin having 3 to 8 carbon atoms, such as hexafluoropropylene (HFP), and/or perfluoro(alkyl vinyl ether) (PAVE) in which the linear or branched alkyl group contains 1 to 5 carbon atoms. Preferred PAVE monomers are those in which the alkyl group contains 1, 2, 3 or 4 carbon atoms, and the copolymer can be made using several PAVE monomers. Preferred TFE copolymers include FEP (TFE/HFP copolymer), PFA (TFE/PAVE copolymer), TFE/HFP/PAVE wherein PAVE is PEVE and/or PPVE and MFA (TFE/PMVE/PAVE wherein the alkyl group of PAVE has at least two carbon atoms). The melt-processible copolymer is made by incorporating an amount of comonomer into the copolymer in order to provide a copolymer which typically has a melt flow rate of about 1-100 g/10 min as measured according to ASTM D-1238 at the temperature which is standard for the specific copolymer. Typically, the melt viscosity will range from 10² Pa•s to about 10⁶ Pa•s, preferably 10³ to about 10⁵ Pa•s measured at 372° C. by the method of ASTM D-1238 modified as described in U.S. Pat. No. 4,380,618. Additional melt-processible fluoropolymers are the copolymers of ethylene or propylene with TFE or CTFE, notably ETFE, ECTFE and PCTFE. Further useful polymers are film forming polymers of polyvinylidene fluoride (PVDF) and copolymers of vinylidene fluoride as well as polyvinyl fluoride (PVF) and copolymers of vinyl fluoride.

While the fluoropolymer component is preferably melt-processible, polytetrafluoroethylene (PTFE) including modified PTFE which is not melt-processible may be used together with melt-processible fluoropolymer or in place of such fluoropolymer. By modified PTFE is meant PTFE containing a small amount of comonomer modifier which improves film forming capability during baking (fusing), such as perfluoroolefin, notably hexafluoropropylene (HFP) or perfluoro(alkyl vinyl) ether (PAVE), where the alkyl group contains 1 to 5 carbon atoms, with perfluoro(ethyl vinyl) ether (PEVE) and perfluoro(propyl vinyl) ether (PPVE) being preferred. The amount of such modifier will be insufficient to confer melt fabricability to the PTFE, generally no more than 0.5 mole %. The PTFE, also for simplicity, can have a single melt viscosity, usually at least 1×10⁹ Pa•s, but a mixture of PTFE's having different melt viscosities can be used to form the fluoropolymer component. Such high melt viscosity indicates that the PTFE does not flow in the molten state and therefore is not melt-processible.

As one skilled in the art will recognize, mixtures of different types of fluoropolymers can be used in the practice of this invention.

The compositions of the present invention include the composition applied to the a fuser roll to form a cover thereon and the composition of the cover, or in more general terms, the film, such as that formed on the surface of the fuser roll. With respect to the composition used to form the cover, these fluoropolymers as used in the present invention are in the form of particles, having an average particle size of from less than 1 μm up to about 100 μm. Many of the fluoropolymers are made by aqueous dispersion polymerization, wherein the fluoropolymer particles as polymerized are typically in the range of 0.01 to 0.3 μm in diameter. The particle sizes disclosed herein are average particle sizes. The fluoropolymer component can also be present in large particle sizes, such as 5 to 100 μm, preferably 10 to 20 μm in diameter. Such large particle sizes can be made by coagulation from dispersion or by spray drying as described in U.S. Pat. No. 6,518,349 B1 (Felix et al.) with an optional grinding step to obtain particles of the desired size. In one preferred embodiment, submicron particles (dispersion particles) and larger particles (powder particles) are both present.

While the fluoropolymers used in the present invention are melt processible, film of the composition containing the fluoropolymer will generally be formed by first providing the composition as a liquid medium, wherein the fluoropolymer particles are dispersed in either an organic solvent or water or a mixture thereof, applying this liquid composition to the substrate to be coated, followed by drying and baking the coating to form a release coating on the substrate. Preferably, the dispersion contains fluoropolymer particles from both particle size groupings mentioned above, e.g., about 15 wt % to about 30 wt % of the submicron size particles together with about 10 wt % to about 20 wt % of the larger size particles.

The liquid medium may either be water or an organic solvent or a mixture thereof. Examples of organic solvents include N-methylpyrrolidone, butyrolactone, high boiling aromatic solvents, include alcohols such as methanol, ethanol, isopropanol and t-butanol, ketones such as acetone and methyl ethyl ketone (MEK), and mixtures thereof

In another embodiment, the composition of this invention can be in the form of powder for powder coating a surface, such as a fuser roll surface, to form a film. In both embodiments, coating from a liquid medium and powder coating, the melt processibility of the fluoropolymer enables the fluoropolymer particles to fuse together during baking to form a continuous film (coating).

Zeolite

This invention is directed to fluoropolymer compositions containing zeolite that exhibit an increase in abrasion resistance in a film formed from the composition as compared to a film formed from fluoropolymer alone. The abrasion resistance of a film from the composition comprising fluoropolymer and zeolite is increased by at least 25%, preferably at least 50%, more preferably at least 100%, and most preferably at least 200%.

When the composition is formed into a film, the total amount of zeolite is at least 3 wt %, preferably in the range of from 3 wt % to 25 wt % based on the dry weight of the film, more preferably 3 wt % to 12 wt %.

Zeolites are reversibly hydrated aluminum silicates generally containing alkali or alkaline earth metal oxides which sometimes can be ion exchanged for other metals or hydrogen. A general structure definition is
M_{x/n}[(AlO₂)ₓ(SiO2)_{y}]mH₂O
wherein M is a cation of valence n, and n is 1 or 2. The ratio of x to y can vary from 1 to a large number as is known in the art. Zeolites include many naturally occurring minerals and synthetic materials. The class of minerals known as feldspathoids is closely related to zeolites and is included herein in the, meaning of the term zeolite. Feldspathoids, including sodalite and ultramarine, with open structure and large cavities are closely related to zeolites. A preferred zeolite is ultramarine blue, an alkali metal aluminum silicate. Generally the particle size of zeolites used in this invention is generally less than 5 micrometers and typically in the range of 0.5 to 3 micrometers.

The addition of ultramarine blue to the composition provides for smooth coatings and an attractive, easily identifiable blue colored film coating.

The pigmentation further provides for increased heat absorption of the composition during application which is advantageous over prior art clear coats to speed up processing time which will be explained in more detail later.

Electrically Conductive Particles

The composition of this invention may contain other additives in addition to fluoropolymer and zeolite. It is generally preferred that coating compositions used on fuser rolls contain electrically conductive particulate material that aid in the dissipation of static buildup. In a preferred embodiment of this invention electrically conductive particulate material such as mica is included in the composition of this invention. The mica is rendered conductive by a coating on the mica flakes such as antimony or tin oxide. The composition could alternately contain graphite or Ketjen Black as an electrically conductive additive. By electrically conductive, it is meant that the surface resistivity of the particulate material as measured with a Pinion meter is less than 10⁸ ohms/square. The effective amount of electrically conductive particulate material to prevent static buildup will depend on the particular material used. For example, when the particulate material is conductive carbon, only about 1 to 2 wt % thereof is needed. When the material is electrically conductive mica (mica coated with electrically conductive material), generally about 3 to 8 wt % thereof is needed. These weights are based on the total dry weight of the composition, which is the same as the baked weight. Both electrically conductive carbon and electrically conductive mica can be used in the same composition to lessen the amount of electrically conductive carbon and reduce its influence on the color of the composition.

Mica is in the form of platelet-shaped particles. The preferred platelet shaped particles of have an average particle size of about 10 to 200 microns, preferably 20-100 microns, with no more than 50% of the particles of flake having average particle size of more than about 300 microns. The mica particles coated with oxide layer are those described in U.S. Pat. Nos. 3,087,827 (Klenke and Stratton); 3,087,828 (Linton); and 3,087,829 (Linton).

In an especially preferred embodiment, the composition of this invention is a liquid dispersion of fluoropolymer, zeolite, and electrically conductive particles. When the composition is formed into a film formed, the total amount of zeolite and electrically conductive particulate material, at least 5 wt % based on the total weight of these ingredients plus the fluoropolymer, preferably in the range of from 5 wt % to 30 wt %, and most preferably 8 wt % to 15 wt %. The composition can contain such large amounts of zeolite and electrically conductive material because of their low densities relative to the density of fluoropolymer, which results in much smaller volume % amounts of these additives. Thus, while the compositions of the present invention will contain from about 85 wt % to about 92 wt % fluoropolymer, the volume % of this component will be much higher.

Film Formation

The invention relates to a process for increasing the abrasion resistance of a fluoropolymer film coating on a fuser roll, comprising incorporating into the fluoropolymer prior to forming the film coating therefrom an effective amount of zeolite sufficient to increase the abrasion resistance of film formed from said composition by at least 25%, preferably at least 50%, as compared to film formed from said fluoropolymer by itself.

In one embodiment, a film of the composition of this invention is formed by applying the composition directly to a substrate as a liquid dispersion by conventional means such as spray-coating, dipping, roller coating or curtain-coating followed by heating and fusing at a temperature of 310° C. to 430° C. to generate film coatings at a thickness in the range of 0.3 mils (7.6 micrometers) to 2 mils (50 micrometers), preferably 0.7 mils (18 micrometers) to 1.4 mils (36 micrometers).

In a preferred embodiment, the dispersion of this invention is applied after first priming the substrate with a primer composition containing a heat resistant polymer binder, the presence of which enables the primer layer to adhere to the substrate. Such binder composition may optionally contain fluoropolymer. The binder component is composed of polymer which is film-forming upon heating to fusion and is also thermally stable. This component is well known in primer applications for non-stick finishes, for adhering a fluoropolymer-containing primer layer to substrates and for film-forming within and as part of a primer layer. The binder is generally non-fluorine containing and yet adheres to the fluoropolymer.

Examples of the non-fluorinated thermally stable polymers include polyamideimide (PAI), polyimide (PI), polyphenylene sulfide (PPS), polyether sulfone (PES), polyarylene-etherketone, and poly(1,4(2,6-dimethylephenyl)oxide) commonly known as polyphenylene oxide (PPO). These polymers are also fluorine-free and are thermoplastic. All of these resins are thermally stable at a temperature of at least 140° C. I

In an alternate embodiment, films are obtained by electrostatic application of powder compositions of this invention directly to a substrate, preferably a fuser roll, or to a primed substrate with subsequent heating and fusing at temperatures in the range of 310° C. to 430° C.

When compositions of this invention are applied as a an overcoat on a primer, the primer layer generally has a thickness of about 4 micrometers to about 15 micrometers and the overcoat generally has a thickness of about 12 micrometers to about 50 micrometers. Multiple overcoats may be applied.

Films of the composition of this invention are formed on any substrate material which can withstand the bake temperature, such as metal in the case of fuser rolls and ceramics, examples of which include aluminum, anodized aluminum, cold-rolled steel, stainless steel, enamel, glass, and pyroceram. The substrate can be smooth, etched or grit blasted.

In a preferred embodiment, a dispersion of fluoropolymer containing zeolite is applied to a metal fuser roll and baked using IR heaters. The presence of zeolite in the composition provides for increased heat absorption of the coating, as compared to clear fluoropolymer coatings. The increased heat absorption results in faster bake times such that the coatings cure more quickly and completed fuser rolls are produced at a faster rate, an important asset of commercial production.

The good release property of the electrically conductive overcoat composition used in the fuser roll application can be improved by undertaking the additional step of honing the surface of the film formed from the composition, using a fine grit such as 600 grit. When the film forms the surface of a roll such as a fuser roll, the roll can be rotated and the hone passed along its surface during such rotation to provide the smoothness desired. This honing removes “peaks” of zeolite and overlying fluoropolymer to smooth the surface so and reduce roughness that could detract from the release property of the film. The resultant honed film provides both improved abrasion resistance and good release property. The smoothness of the film surface desired is generally determined visually, i.e, the surface of the film should have a smooth surface generally free of topography.

Preferred products having surface films formed using compositions of the present invention include fuser rolls and belts, pipes, conveyors, chemical processing equipment, including tanks, chutes, roll surfaces, cutting blades, iron sole plates, cookware, bakeware etc.

### TEST METHODS

Abrasion Test—Thrust Method

The Falex friction and wear test machine available from the FALEX corporation, Sugar Grove, Ill. and designated in ASTM D3072 is used to determine the wear index of a coating. A stationary aluminum washer specimen is placed in the lower specimen holder. The washer configuration is designated in ASTM D3072. A coated rotating wafer specimen is mounted on the rotary spindle in contact with the lower stationary aluminum washer specimen. A load of 21.8 kilograms is then applied. The specimen rotation speed is set at 500 rpm. After every 5,000 cycles, the test is stopped and the weight loss is recorded. The test continues up to 30,000 cycles or when the substrate begins to show through (the substrate becomes visible). The wear index is determined in total cycles of abrasion per the total weight loss in milligrams (cycles/milligram of wear).

Abrasion Test—Roller Abrasion

An abrasion resistance test meant to simulate abrasion against a fusion roll by paper in a copier machine is used to determine the wear rate of a coating. The diameter of the test roller is carefully and accurately measured. The test roller is mounted in a rotation configuration. Standard paper cash register tape, 2.25 inches (5.7 cm) wide is pressed against the roller by applying a 610 g weight to the paper along a 0.25 inch (0.64 cm) contact path. The roller rotates at 60 rpm. After every 10 rotations, the paper tape moves 0.29 inches (0.74 cm) to apply new paper to the surface being abraded. The temperature is room temperature, air conditioned approximately 75° F. (24° C.). After 10,000 cycles or when the substrate begins to show through, the test is stopped and the rotations are recorded. The diameter of the roller on the worn area is measured. The wear rate is calculated as cycles per micron of wear.

Release Test

Release of the coating composition on a fuser roll was tested on a commercial copier machine, Ricoh AF 350. The coating was judged by the number of copies produced without toner contamination. Toner contamination is a result of poor release of toner from the fuser roll such that toner builds up on the roll resulting in poor quality copies.

### EXAMPLES

In the following Examples, substrates for coating are cleaned by baking 30 min @ 800° F. (427° C.) and grit blasted with 40 grit aluminum oxide) to a roughness of approximately 70-125 microinches Ra. Liquid coatings are applied by using a spray gun, Model Number MSA-510 available from DeVilbiss located in Glendale Heights, Ill.

For Example 1, a layer of primer is applied on a rotating wafer specimen of steel followed by baking at 66° C. for 5 minutes. The rotating wafer configuration is designated in ASTM D3072. The dry film thickness (DFT) of the primer layer is about 10 micrometers. Overcoat is applied two times followed by baking at 66° C. for 5 minutes and then baked at 149° C. for 10 minutes. The coated disc is finally baked at 399° C. for 5 minutes. The total dry film thickness (DFT) of the coating is around 100 micrometers. This coated specimen is tested by the Thrust Abrasion Weight Loss method.

The primer used in the Examples has the following pre-bake composition:

TABLE 1
Liquid Primer

| Ingredients | | Wt % |
|---|---|---|
| Fluoropolymer | | |
| | PTFE dispersion | 12.8 |
| | PFA dispersion | 8.8 |
| | FEP dispersion | 9.5 |
| Polymer binder | | |
| | Polyamideimide | 4.6 |
| Colloidal Silica | | 2.9 |
| Solvents | | |
| | Water | 50.4 |
| | Other Organics* | 7.3 |
| Pigments | | 3.4 |
| Dispersing Agent | | 0.3 |
| Total | | 100 |

*Other organics may include solvents such as N-methyl-2-pyrrolidone, MIBK (methyl isobutyl ketone), hydrocarbons such as heavy naphtha, xylene etc., furfuryl alcohol, triethanol amine or mixtures thereof.
PTFE dispersion: 59-61% solids PTFE, particle size 170-210 nm, melting point (1st) 337° C., (2nd) 317° C.
PFA dispersion: 58-62% solids PFA, particle size 185-245 nm, PPVE content 2.9-3.6 wt %, MFR 1.3-2.7 g/10 min @ 372° C.
FEP dispersion: 54.5-55.5% solids FEP, particle size 160-220 nm, HFP content 9.3-12.4 wt %, MFR 11.8-21.3 g/10 min @ 372° C.

### Example 1

### Abrasion Resistance of Fluoropolymer and UMB

A series of wafer substrates cleaned and coated with primer are prepared as described above. Overcoats are applied to the primed substrates. The overcoats formed in Example 1 have the following composition as shown in Table 2. The ultramarine blue (UMB) loading ratio is varied in the range of from 0 wt % to 20.0 wt % of dry film. The abrasion test results for samples tested by the Thrust Abrasion Weight Loss method described above are shown in Table 3 for different UMB loadings.

TABLE 2
Topcoat composition modified by ultramarine blue

| Ultramarine blue | | 0.0 | 4.0 | 8.0 | 12.0 | 16.0 | 20.0 |
|---|---|---|---|---|---|---|---|
| loading ratio in dry film wt % | | | | | | | |
| Fluoropolymer | | | | | | | |
| | PFA dispersion | 37.9 | 37.9 | 37.9 | 37.9 | 37.9 | 37.9 |
| | PFA powder | 12.3 | 12.3 | 12.3 | 12.3 | 12.3 | 12.3 |
| Solvents | | | | | | | |
| | Water | 24.5 | 23.0 | 21.3 | 19.5 | 17.5 | 15.3 |
| | Organics* | 17.4 | 17.4 | 17.4 | 17.4 | 17.4 | 17.4 |
| Additives | | | | | | | |
| | Conductive mica | 1.89 | 1.89 | 1.89 | 1.89 | 1.89 | 1.89 |
| | Ultramarine blue*** | 0.00 | 1.55 | 3.22 | 5.06 | 7.06 | 9.27 |
| | Other additives** | 0.203 | 0.203 | 0.203 | 0.203 | 0.203 | 0.203 |
| Dispersing Agent | | 5.49 | 5.49 | 5.49 | 5.49 | 5.49 | 5.49 |
| Total | Wt % | 100 | 100 | 100 | 100 | 100 | 100 |

*Other organics may include solvents such as N-methyl-2-pyrrolidone, diethylene glycol monobutyl ether, hydrocarbons such as heavy naphtha, xylene etc., Oleic acid, triethanol amine or mixtures thereof.
**Other additives include non-conductive mica, carbon black.
***Ultramarine blue and water are combined into a dispersion.
PFA dispersion: 58-62% solids PFA, particle size 185-245 nm, PPVE content 2.9-3.6 wt %, MFR 1.3-2.7 g/10 min @ 372° C.
PFA Powder: TFE/PPVE fluoropolymer resin containing 3.5-4.6 wt % PPVE having a melt flow rate of 9.7-17.7 g/10 min and an average particle size of 20 micrometers.

TABLE 3
Thrust Abrasion Test Results

| | | | | | | |
|---|---|---|---|---|---|---|
| Ultramarine blue | 0.0 | 4.0 | 8.0 | 12.0 | 16.0 | 20.0 |
| loading ratio in | (control) | | | | | |
| dry film wt % | | | | | | |
| Wear index | 263.2 | 444.7 | 416.2 | 681.8 | 909.1 | 937.5 |
| (cycles per 1 mg wear) | | | | | | |

The overcoat layers formed in the following Examples Comparative A and 2 have the following pre-bake compositions:

TABLE 4
Overcoat Compositions for Examples A, 2

| | | |
|---|---|---|
| Ultramarine blue loading | 0 (Control) | 6.4 |
| ratio in dry film wt % | | |

| | A | 2 |
|---|---|---|
| Ingredient | Wt % | Wt % |
| Fluoropolymer | | |
| PFA dispersion | 37.9 | 36.3 |
| PFA Powder | 12.3 | 11.7 |
| Solvents | | |
| Water | 24.8 | 25.7 |
| Other Organics* | 17.4 | 16.7 |
| Pigments | | |
| Conductive mica | 1.9 | 1.8 |
| Ultramarine Blue | — | 2.4 |
| Other pigments** | 0.2 | — |
| Dispersing Agent | 5.5 | 5.4 |
| Total | 100.0 | 100.0 |

*Other organics may include solvents such as N-methyl-2-pyrrolidone, diethylene glycol monobutyl ether, hydrocarbons such as heavy naphtha, xylene etc., Oleic acid, triethanol amine or mixtures thereof.
**Other pigments include non-conductive mica, carbon black,
PFA dispersion: 58-62% solids PFA, particle size 185-245 nm, PPVE content 2.9-3.6 wt %, MFR 1.3-2.7 g/10 min @ 372° C.
PFA Powder: TFE/PPVE fluoropolymer resin containing 3.5-4.6 wt % PPVE having a melt flow rate of 9.7-17.7 g/10 min and an average particle size of 20 micrometers.

### Comparative Example A—Control Coating

A layer of primer as described above is applied to an aluminum test roller (10.5 in, 26.7 cm long; 1.125 in, 2.9 cm diameter) followed by baking at 150° C. for 5 minutes. The dry film thickness (DFT) of the primer layer is 8-12 micrometers. Overcoat A containing no ultramarine blue and no micropulp is applied followed by baking at 800° F. (427° C.) for 10 minutes. The total dry film thickness (DFT) of the coating is 35-45 micrometers. This coating when tested in the roller abrasion test as described above results in 1068 cycles/micron wear. The coating was subjected to the above described release test by testing in a commercial copier machine, Ricoh AF 350. Toner contamination resulted after about 35,000 copies due to coating wear.

### Example 2

### Ultramarine Blue Modification

A layer of primer as described above is applied to an aluminum test roller (10.5 in, 26.7 cm long; 1.125 in, 2.9 cm diameter) followed by baking at 150° C. for 5 minutes. The dry film thickness (DFT) of the primer layer is 8-12 micrometers. Overcoat 2 containing ultramarine blue is applied followed by baking at 800° F. (427° C.) for 10 minutes. The total dry film thickness (DFT) of the coating is 35-45 micrometers. This coating when tested in the roller abrasion test as described above results in 3814 cycles/micron wear. The coating was subjected to the above described release test by testing in a commercial copier machine, Ricoh AF 350. Toner contamination resulted after about 50,000 copies due to coating wear.

TABLE 5
Summary of Roller Abrasion Tests

| | A | 2 |
|---|---|---|
| | Control | UMB |
| UMB wt %, film | 0 | 6.4 |
| Cycles per micron | 1068 | 3814 |

1. Process for increasing the abrasion resistance of a fluoropolymer film coating on a fuser roll, comprising incorporating into the fluoropolymer prior to forming said film coating therefrom an effective amount of zeolite sufficient to increase the abrasion resistance of film formed from said composition by at least 25% as compared to film formed from said fluoropolymer by itself.

2. The process of claim 1 wherein the abrasion resistance of a film formed a composition comprising fluoropolymer and an effective amount of zeolite is increased at least 50% compared to film formed from said fluoropolymer by itself.

3. An overcoat composition comprising fluoropolymer and an effective amount of zeolite to increase the abrasion resistance of film formed from said composition by at least 25% compared to film formed from said fluoropolymer by itself.

4. An electrically conductive overcoat composition comprising fluoropolymer, an effective amount of electrically conductive particulate material and an effective amount of zeolite to increase the abrasion resistance of film formed from said composition by at least 25% compared to film formed from said fluoropolymer by itself.

5. The composition of claim 3 wherein the amount of said zeolite present is at least 3 wt % of the dry film composition the resultant composition when formed into a film coating for a fuser roll being resistant to adhesion of copier toner thereto.

6. The composition of claim 5 wherein the amount of said zeolite present is about 3 wt % to about 25 wt %.

7. The composition of claim 5 also containing an effective amount of electrically conductive particulate material.

8. The composition of claim 3 wherein said zeolite is alkali metal aluminum silicate.

9. The composition of claim 5 wherein said silicate is ultramarine blue pigment.

10. The composition of claim 3 in the form of a film coating for a fuser roll.

11. The composition of claim 3 dispersed in a liquid medium.

12. The composition of claim 3 in the form of a powder.

13. Film of the composition of claim 3.

14. The film of claim 12 as a film coating on a fuser roll.

15. The use of the composition of claim 3 for forming a film coating on a fuser roll. (for EP appln)
